(19) United States
(12) Patent Application Publication
(10) Pub. No.: US 2023/0265018 A1
(43) Pub. Date: Aug. 24, 2023

(54) MOLTEN METAL PROCESSING APPARATUS

(71) Applicants: Morganite Crucible (India) Limited, Maharashtra (IN); Morgan Molten Metal Systems GmbH, Berkatal-Frankenhain (DE)

(72) Inventors: Ramdas Ananda Chitalkar, Maharashtra (IN); Nikhil Patil, Maharashtra (IN); Dieter Heumannskaemper, Berkatal-Frankenhain (DE)

(73) Assignees: Morganite Crucible (India) Limited, Maharashtra (IN); Morgan Molten Metal Systems GmbH, Berkatal-Frankenhain (DE)

(21) Appl. No.: 18/005,378

(22) PCT Filed: Jul. 6, 2021
(86) PCT No.: PCT/GB2021/051719

§ 371 Date: Jan. 13, 2023

(30) Foreign Application Priority Data
Jul. 15, 2020 (IN) 202021030150

(51) Int. Cl. C04B 35/80; C04B 35/52; C04B 35/565; C04B 35/63; C04B 35/628

(52) U.S. Cl. CPC C04B 35/80; C04B 35/522; C04B 35/565; C04B 35/6316; C04B 35/62802; C04B 2235/5232; C04B 2235/36; C04B 2235/3208; C04B 2235/3217; C04B 2235/3418; C04B 2235/425; C04B 2235/762; C04B 2235/767; C04B 2235/3826; C04B 2235/3834; C04B 2235/9676; C04B 2235/80; C04B 2235/604; C04B 2235/5427; C04B 2235/5463; C04B 2235/349; C04B 2235/5436; C04B 2235/428; C04B 2235/405; C04B 2235/3409; C04B 2235/77; C04B 2235/96; C04B 2235/75

(57) ABSTRACT

The present invention relates to a composite material comprising wollastonite fibres embedded within a ceramic matrix. The wollastonite fibres are bonded to the ceramic matrix by a glassy bonding phase comprising a glass component comprising at least 80 wt % of oxides of calcium, silicon and aluminium. The material is used in the processing of molten metal, e.g. as a pump, degasser, flux injector or scrap submergence device.

### FIELD

The present invention relates to apparatus from processing molten metal and, in particular, pumps, degassers, flux injectors and submergence devices.

### BACKGROUND

Molten aluminium has high affinity towards hydrogen. This typical characteristic of aluminium results in hydrogen gas entrapment in casting during solidification. Entrapped hydrogen forms micro porosity and blow holes, resulting in casting rejections. Hence, the process of minimizing gas content from aluminium alloys before casting (formally known as degassing) has at-most importance in an aluminium foundry. Different techniques used for removal of gas content includes:
purging tablet of chlorine or chlorine free base
Purging inert gas (e.g. Ar, N₂) through ceramic rod/pipe,
purging inert gases through rotary degassing too

However, rotary degassing is the most popular choice today for all sizes of aluminium foundries due to higher efficiency & reliability. Rotary degassing efficiency has very high dependency on rotor design, which is the enabler of creating smaller bubbles & distribution of the inert gas throughout the liquid metal.

The longevity of rotor and associated shafts are dependent upon the rotor design and the material of construction. Rotor and shafts may be produced from the same or different materials. The shaft and rotor material are often produced from graphite due to its thermal shock resistance. However, graphite apparatus (e.g. rotor) is susceptible to oxidation and erosion and, as such, may need be regularly replaced. As such, the rotor is usually detachingly connected to the shaft using a mechanical connection (e.g. male/female threaded connection joint).

While there is a large variety of rotor designs available, many of the degassing systems have scope for further improvements in respect to improved longevity, flexural strength and oxidation-resistance.

### SUMMARY OF THE INVENTION

In a first aspect of the present disclosure, there is provided a molten metal apparatus comprising wollastonite fibres embedded within a ceramic matrix, wherein the wollastonite fibres are bonded to the ceramic matrix by a glassy bonding phase comprising a glass component comprising oxides of calcium, silicon and aluminium.

There is also provided a composite material comprising wollastonite fibres embedded within a ceramic matrix, wherein the wollastonite fibres are bonded to the ceramic matrix by a glassy bonding phase comprising a glass component comprising at least 80 wt % of oxides of calcium, silicon and aluminium.

The combination of the wollastonite fibres and the glassy bonding phase enables a strong bond between the fibres and the glassy bonding phase that results in an apparatus which has excellent mechanical properties, including impact and flexural strength, oxidation resistance, non-wetting and thermal resistance. In a preferred embodiment, the wollastonite bondedly is embedded into the glassy bonding phase. The glassy bonding phase is preferably partially derivable from the wollastonite fibre and, as such, the wollastonite fibres merge into the glassy bonding phase, thereby enabling the mechanical properties (e.g. flexural strength) of the wollastonite fibres to impact throughout the adjoining glassy bonding phase and the composite material.

The composite material may also comprise a carbon compound. The carbon compound may comprise graphite and/or a carbonised resin (e.g. amorphous carbon).

The glassy bonding phase may comprise a glass component and a crystalline component. The crystalline component comprises crystals which have been formed in-situ during the formation of the composite material. These crystals are generally less than 10 micron or less than 5 micron in diameter and are dispersed throughout the glass component. In some embodiments, the glassy bonding phase further comprises mullite. Preferably, the mullite is derivable and formed from a ceramic matrix precursor material (e.g. clay). The mechanical properties of the mullite advantageously combines with the glass component of the glassy bonding phase and wollastonite fibres.

In one embodiment, the composite material comprises:
0.5 to 20 wt % (or 2 wt % to 15 wt %) wollastonite fibres;
0.5 to 40 wt % (or 5 wt % to 30 wt %) glassy bonding phase;
0 to 50 wt % (or 10 wt % to 35 wt %) ceramic matrix;
0 to 50 wt % (or 5 wt % to 25 wt %) carbon material; and
0 to 15 wt % (or 1 wt % to 5 wt %) other additives (e.g. Si, Fe—Si, borax).

Wherein the sum of the abovementioned components is greater than 90 wt % of the composite material.

Preferably, the sum of wollastonite fibres+glass bonding phase+ceramic matrix+carbon material+other additives is greater than 95 wt % or greater than 99 wt % or 100 wt % of the composite material.

The wollastonite fibres preferably have an aspect ratio of at least 3:1, with the fibre length preferably being at least 0.5 μm or at least or 10 μm or 50 μm at least or at least 50 μm 100 μm or at least 500 μm or at least 1000 μm.

The glassy bonding phase is preferably derivable from a clay and/or alumina material and more preferably a clay material which is able to form mullite crystals upon firing at a sufficient temperature for a sufficient period of time. The glass component of the glassy bonding phase comprises CaO, Al₂O₃ and SiO₂. Preferably, CaO+Al₂O₃+SiO₂>80 wt % or greater than 90 wt % or greater than 95 wt % of the glass component. While not wanting to be bound by theory it is thought that at least a portion of the CaO and/or SiO₂ in the glass component is derived from wollastonite fibres (i.e. a portion of the wollastonite fibres are consumed in the formation of the composite material). Components of the glassy bonding phase may also contain other glass forming components in trace amounts, such as alkaline earth metals and/or alkali metal (e.g. oxides of K, Na, Mg and Fe).

As the glassy bonding phase may be generated through the dissolution of calcium from the wollastonite fibres, the concentration of calcium in the glassy bonding phase may be higher immediately adjacent the wollastonite fibres, with the calcium concentration decreasing with increasing distance from the wollastonite fibres.

The ceramic matrix is preferably selected for its combination of thermal and mechanical properties and may be selected from the group consisting of silica;

alumina; carbides of Si, Ti, W, Ta, Nb, Zr, Hf, V, Cr, Mo; silicon nitride; magnesia; zirconia; boron nitride; aluminium nitride; or combinations thereof.

The ceramic matrix may comprise a silicon carbide, e.g. a beta silicon carbide and/or alpha silicon carbide.

The carbon material is preferably graphite and/or carbonaceous material derivable from an organic binder used in the formation of the composite material.

The glassy bonding phase may bond the wollastonite fibres, ceramic matrix and/or graphite together.

The additives may comprise carbonised organic binder; carbon oxidation inhibitors or precursors thereof. Additives may include silicon metal, FeSi, aluminium, boron, alumina-silicate (e.g. clay), borax and/or boric acid. Additives preferably make up between 1.0 to 15 wt % or between 2.0 and 10 wt % of the composite material.

In a preferred embodiment, the composite material comprises:
0.5 to 10 wt % wollastonite fibres;
0.5 to 30 wt % glassy bonding phase;
10 to 50 wt % silicon carbide;
5.0 to 50 wt % graphite; and
1 to 15 wt % other additives.

Preferably the sum of wollastonite+glassy bonding phase+silicon carbide+graphite+other additives is at least 90 wt % of the composite material.

In another embodiment, the composite material comprises:
0.5 to 10 wt % wollastonite fibres;
0.5 to 30 wt % glassy bonding phase;
10 to 50 wt % silicon carbide;
5.0 to 50 wt % carbon compound; and
1 to 15 wt % other additives
   wherein the carbon compound comprises graphite and amorphous carbon.

The amorphous carbon may be derived from a resin binder used in the starting formulation. The resin binder may be carbonised during the sintering process, with a portion of the carbonised resin reacting with silicon metal to form a beta silicon carbide. The beta silicon carbide is typically in the form of fibres. The beta silicon carbide in combination with the glassy bonding phase function as an oxidation inhibitor for the graphite, reducing ingress of oxygen which is able to react with the graphite.

Preferably, the glassy bonding phase is partially derived from an alumina-silicate clay and the wollastonite fibres. The glassy bonding phase preferably comprises mullite. The mullite is preferably formed in situ during a firing/sintering step which partially converts the clay, or other mullite precursor material, to mullite.

The glassy bonding phase may comprise mullite crystals and other alumina and/or silica crystals disperse within a glass phase. The crystal size distribution has a d50 of typically less than 3 μm. The proportion of oxides of aluminium and silica in the glass component may be at least 60 wt %. The glassy bonding phase or glass component thereof preferably comprises at least 60% or at least 70 wt % or at least 75 wt % or at least 80 wt % or at least 85 wt % or at least 90 wt % aluminium and silicon in an oxide form. The glassy bonding phase preferably comprises a refractory glass phase/component which has a high melting point (e.g. greater than 900° C. or greater than 1000° C.), such that it maintains its mechanical strength at the operating temperature of the molten metal apparatus (e.g. 700-800° C.). Typically the glass phase has less than 20 wt % or less than 15 wt % or less than 10 wt % or less than 5 wt % alkali or alkaline earth metal oxides. The high alumina/silica content combined with the low alkali and alkaline earth metal oxide content of the glass phase, combined with the dispersion of hard ceramic particles therein, results in a corrosive and erosion resistant refractory binder capable of providing long lasting mechanical and oxidation inhibiting properties. Furthermore, the softening of the glass phase during the sintering phase reduces the porosity of the composite material further improving the material's mechanical properties.

The graphite content is preferably between 20 and 40 wt %. Higher amounts of graphite may result in the apparatus being more susceptible to oxidation and erosion. Lower graphite levels may not have sufficient molten metal non-wetting properties or shock resistant properties.

The silicon carbide content is preferably between 20 wt % and 40 wt % to provide the desired mix of mechanical properties when combined with the other components of the composite.

It has been found the above combination of materials provides an excellent balance of resistance to thermal shock, mechanical strength, non-wetting, thermal resistance (insulative) and oxidation resistance.

The apparatus may be selected from the group consisting of a pump, a degasser, a flux injector and a scrap submergence device. In a preferred embodiment, the apparatus is a shaft and/or rotor of a degasser. In a more preferred embodiment, the apparatus is a one piece shaft and impeller of a degasser. The composite material of the present disclosure has been found to have sufficient thermal shock resistance; mechanical strength and oxidation resistance to withstand the extreme environment of a single piece shaft and rotor. Shafts and rotors have conventionally been constructed as separate pieces and mechanically joined, due to the need to replace graphite based rotor which have shortened life spans due to oxidation of the graphite material.

The unique properties of the composite material (improved impact and flexural strength) enable a one piece shaft-rotor design to be created which eliminates the shaft-impeller connection, which is often a mechanical type connection (i.e. the shaft has a threaded end which screwed into a cavity in the rotor). The connection point is prone to failure with stresses concentrating at the connection point, which typically comprises a right or angle (e.g. 90°) joint.

In contrast, the one piece designs of the present disclosure have no connection point, with the shaft gradually increasing in diameter proximal to the rotor. Preferably, the interface angle between the shaft and rotor is preferably at least 100° or at least 110° or at least 120° or at least 130° or at least 140° or at least 150° The intersection or joint between the surface defining the rotor and the surface defining the shaft is preferably defined by a radius of between 5 mm and 180 mm. The radius of the intersecting arc is formed through the machining process, which does not readily produce angular intersections.

In a second aspect of the present invention there is provided a process for producing an apparatus according to the first aspect of the present invention comprising the steps of:
a. Providing a precursor composite mixture of wollastonite fibres, a ceramic matrix and a glassy bonding phase or precursors thereof.
b. Depositing the mixture into a mould.
c. Sintering the mixture at a temperature of at least 800° C. for sufficient time to partially transform the wollastonite fibre into the glassy bonding phase.

The mixture may be sintered at a temperature of at least 1000° C. or at least 1100° C. or at least 1200° C. or at least 1300° C. In this embodiment the mixture may be sintered for sufficient time to form mullite within the glassy bonding phase.

The amount of wollastonite which is converted to the glassy bonding phase is preferably between 10 wt % and 90 wt % or between 20 wt % and 85 wt % or between 25 wt % and 60 wt % of the wollastonite in the pre-sintered mixture. A portion of the wollastonite phase may also be converted to an anorthite phase during the sintering process. The conversion of wollastonite may be determined through XRD analysis of the pre-sintered and sintered composite material.

The mixture may further comprise graphite and/or an organic resin.

The mixture preferably comprises a “green” binder which may be an organic binder, such as a resin, tar or sugar binder or an inorganic binder, such as clay. The “green” binder provides sufficient strength of the composite material for shaping and handling prior the firing/sintering step. Furthermore, during the firing step the organic resin may provide a source of carbon, which may react with silicon metal powder to form the beta form of silicon carbon which functions as an oxidation inhibitor for the carbon/graphite within the ceramic matrix and provides additional strength. In embodiments comprising an organic resin binder, the resin bond mix may comprise:
5 to 40 wt % graphite
10 to 40 wt % silicon carbide (preferably alpha phase)
1 to 10 wt % clay
4 to 10 wt % alumina
1 to 10 wt % wollastonite fibres
5 to 15 wt % organic resin (e.g. liquid Novolac™ with about 80% solids)
0 to 10 wt % additives (e.g. FeSi and/or Si, additives used in vacuum impregnation)

In one embodiment the glassy bonding phase precursor comprises 1 to 35 wt % (preferably 2 or 5 or 10 to 25 wt %) clay. The clay preferably comprises at least 70 wt % or at least 75 wt % or at least 80 wt % of at least 85 wt % or at least 90 wt % aluminium and silicon in an oxide form. Preferably, at least a portion, and more preferably the majority, of the calcium in the glassy bonding phase is derived from the wollastonite fibres. Typically, the clay preferably has less than 20 wt % or less than 15 wt % or less than 10 wt % or less than 5 wt % alkali and/or alkaline earth metal oxides. In one embodiment, the clay comprises less than 5 wt % or less than 3 wt % alkali metal oxides.

The high alumina/silica content combined with the low alkali and alkaline earth metal oxide content of the resultant glassy bonding phase, combined with the dispersion of hard ceramic particles therein, results in a corrosive and erosion resistant refractory binder capable of providing long lasting mechanical and oxidation inhibiting properties, particularly at an operating temperature below 1000° C. or below 950° C. or below 900° C.

Prior to sintering the mixture, the moulded material may be pressed and preferably isostatically pressed. The iso-pressing (isostatic pressing) may be performed over a range of pressures (e.g. 10 to 400 MPa). Isostatic pressing densifies the green ceramics, whilst reducing internal stresses which result in subsequent cracking during firing or in use.

The application of a refractory sealant may also function as an oxidation inhibitor. The refractory sealant may be applied via a vacuum impregnation step after the firing step. This step preferably comprising vacuum impregnating the outer surface of the apparatus with an impregnation solution (e.g. a borax-boric acid; and /or aluminium phosphate; and/or calcium/magnesium sulphate solution) and then firing.

There is also provided use of the composite material as described above in the processing of a molten metal.

The composite material may be exposed to temperatures less than 1000° C.

### BRIEF DESCRIPTION OF THE FIGURES

FIG. 1a is a schematic diagram of the process of producing an apparatus of the present disclosure using clay as a green binder.

FIG. 1b is a schematic diagram of the process of producing an apparatus of the present disclosure using carbonaceous resin as a green binder.

FIG. 2 is are XRD spectra of a composite material of the present disclosure (top spectra) compared to a conventional composite material (bottom spectra).

FIG. 3 is a SEM image of wollastonite fibres used in the composite material of the present disclosure.

FIG. 4 is a SEM image of the composite material after being sintered at 1260° C.

FIG. 5 is another a SEM image of the composite material after being sintered at 1260° C.

FIG. 6a is a photograph of a one piece shaft rotor of the present disclosure after pressing.

FIG. 6b is a photograph of a one piece shaft rotor of the present disclosure after sintering and machining.

FIG. 7 is a SEM image of a composite material derived from a resin bonded formulation.

### DETAIL DESCRIPTION OF A PREFERRED EMBODIMENT

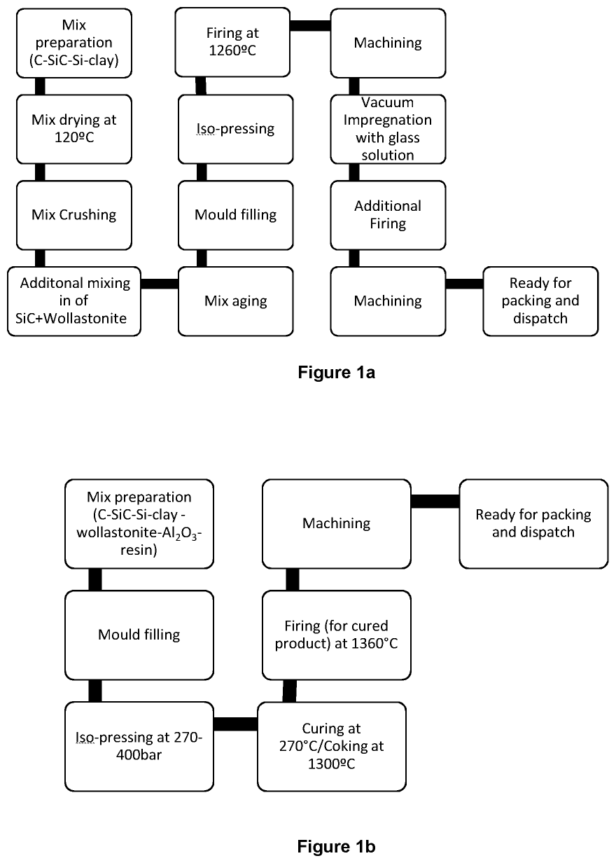

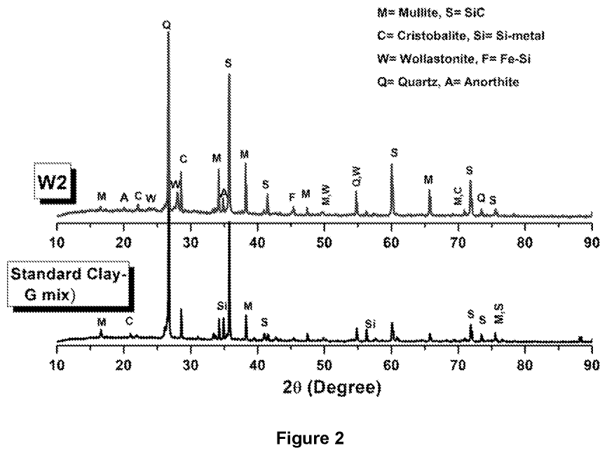

As illustrated in FIG. 1 a, the apparatus of the present disclosure may be produced through mixing graphite, a ceramic (e.g. SiC), a source of alumina (e.g. clay) and additives (e.g. FeSi and/or silicon metal as an oxidation inhibitor for the graphite).

The mixture is dried at 120° C. to reduce the moisture level down from about 15 to 30 wt % to less than 1.0 wt % or less than 0.5 wt %. The mixture is then crushed to achieve an average particle size distribution of 10 μm to 2 mm. Wollastonite fibre and further SiC then added and mixed, with the homogeneous mixture aged at least 8 hrs before drying and filling the moulds of the apparatus. The moulds are then iso-pressed at 400 bar for 25-60 seconds after which the green ceramic is dried at 120° C. before being sintered at 1260° C. for sufficient time for the wollastonite to partially react with the clay to form a SiO₂—CaO—Al₂O₃ glassy bonding phase. Preferably, the green ceramic is sintered for sufficient time at the sintering temperature to transform some of the clay material into mullite.

It will be understood that a combination of sintering temperature and sintering time is able to produce the glassy bond and the mullite. For the formation of the glassy bond, the sintering temperature is preferably at least 800° C. or at least 900° C. or at least 1000° C. or at least 1100° C. or at least 1200° C. For the formation of the mullite phase the sintering temperature is preferably at least 1000° C. or at least 1100° C. or at least 1200° C. or at least 1300° C.

The moulded apparatus may then be machined to the required shape and surface finish. An optional sealant may be applied, such as the vacuum impregnation of the apparatus with a borax-boric acid solution and subsequent firing at 980° C., followed by additional machining if required.

In a variation, the inorganic binder (e.g. clay) may be partially replaced with a carbonaceous resin binder. Within this embodiment, the glassy bonding phase forms by reaction of fibre with alumina/clay present in the mix. An alternative source of alumina may be required from which the glassy bond phase could be derived from. In this variant, the glassy bonding phase plus a beta form of silicon carbide act as both a binder and a graphite oxidation inhibitor.

### EXAMPLES

Raw Materials:

SiC Particle Size—75-400 μm, Purity—4=95%

Graphitep13 Particle Size—200-600 μm, Purity—>92%

Clay Particle Size—5-40 μm, loss on Ignition—10-13%

clay composition: alumina 28-35%, Silica 50-58%, Iron oxide 2-3%, titanium oxide 1-3% and alkali and alkaline metals 2-3%.

FeSi Particle size—50-180 μm, Silicon—71.5-80%

Borax—Particle size<75 μm, % H2O at 110° C.-<1=0.3%

Si metal Particle size—40-100 μm, Purity—min 96%

Binder Resin—Novolac™ with about 80% solids

Viscosity at 75° C.-13-17 Poise, Solid content at 160° C., 2hrs—79.5-82%

Transverse Bending Strength (TBS), Porosity and Oxidation Resistance (Graphite)

Composite mixtures (standard clay bonded mix) were formed comprising:

36 parts by weight silicon carbide

29 parts by weight graphite

21.5 parts by weight clay

5 parts by weight silicon metal

2 parts by weight FeSi

0 (C-1), 2.5 (E-1), 5.0 (E-2) and 7.5 parts (E-3) wollastonite fibre

The mixture was moulded into test samples (200 m×150 mm×150 mm) and sintered at 1260° C. for 60 minutes. The test samples were then tested for density, porosity, flexural strength and oxidation resistance, with the results presented in Table 1.

TABLE 1

| | | E-1 | E-2 | E-3 |
|---|---|---|---|---|
| | | 2.5 wt % | 5.0 wt % | 7.5 wt % |
| | C-1 | Wollastonite | Wollastonite | Wollastonite |
| Density, gm/cc | 2.19 ± 0 | 2.19 ± 0 | 2.17 ± 0 | 2.16 ± 0 |
| Porosity, % | 14 ± 0 | 12 ± 0 | 13 ± 0 | 13 ± 0 |
| TBS, MPa | 17.44 ± 1 | 22.67 ± 1 | 21 ± 1 | 21.22 ± 2 |
| weight loss % | 5.8 | 4.8 | 4.9 | 4.5 |
| 750° C., 1 hr | | | | |

The results indicate that the additional wollastonite fibre results in a significant increase in flexural strength, with example E-1 having about 30% greater flexural strength compared to the test sample produced without wollastonite fibre. Furthermore, the additional of wollastonite fibre also increased oxidation resistance. Improved oxidation resistance (as indicated with a lower % weight loss) is thought to be as a result of an increase in the glassy bonding phase from the dissociation of the wollastonite fibres around 800° C. and higher, which results in a reduced porosity of the composite.

FIG. 2 provides a comparison of the sample E-1 (top XRD spectra) with the comparative example C-1 (bottom XRD spectra). The wollastonite crystalline structure is clearly visible along with increased levels of mullite, which the disassociated wollastonite may have also contributed to. The graphite phase was not characterised in the XRD analysis. It is estimated that the proportion of wollastonite fibres that were transformed into the glassy bonding phase or anorthite phase (CaSi₂Al₂O₈) is approximately 78 wt %.

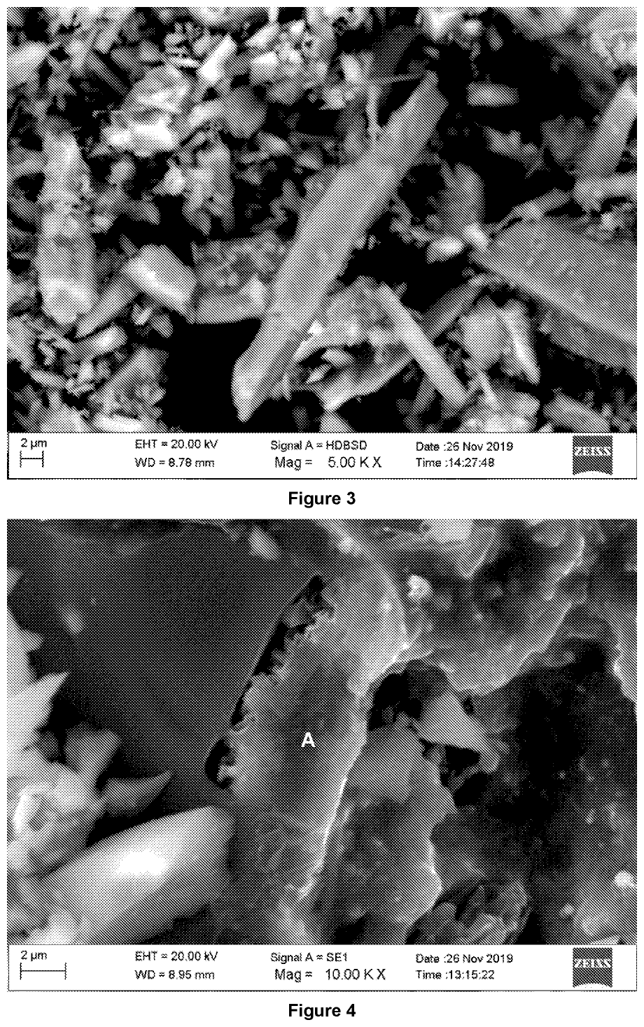

FIG. 3 is an SEM image of wollastonite fibres as received, with the fibres being of various length in the range of about 2 μm to 50 μm. FIG. 4 is an SEM of the composite material after it has been sintered at 1260° C. The EDS analysis of particle (A) indicates that it comprises Ca—Si—Al—Oand trace amount of Na and K indicative of the glassy bonding phase. However, the elongated shape of particle A is suggestive that the core of the particle comprises wollastonite and the mechanical properties thereof. It is postulated that due to the gradual and incomplete disassociation of the wollastonite fibres during the sintering process that there will be a gradient of calcium concentration stemming from the interface of the wollastonite fibre; the glassy bonding phase immediately adjacent the fibre that the calcium is mitigating into; and the glass phase further removed from the wollastonite fibre, which may still comprise a composition similar to that of the clay from which is was derived. EDS analysis confirms the concentration gradient calcium extending from the fibre/glassy bonding phase boundary. The differences in glass composition means that the glassy bonding phase comprises a portion which has a lower melting point conducive to lowering the composite material's porosity and portion which has a higher melting point conducive to increasing the erosive resistance of the composite material.

EDS analysis also confirmed higher concentration of Al at the grain boundaries in association with Si and Ca, which is consistent with the formation of anorthite during the sintering process.

The glass component of the glassy bonding phase had a composition of approximately 20 wt % CaO, 37 wt % Al₂O₃ and 43 wt % SiO₂ immediately adjacent the wollastonite fibre.

Whilst, on a practical level, it may be difficult to analyse regions proximal and distal of the wollastonite fibre, a variation of glass composition in terms of calcium level will also be consistent with this glassy bonding phase formation mechanism.

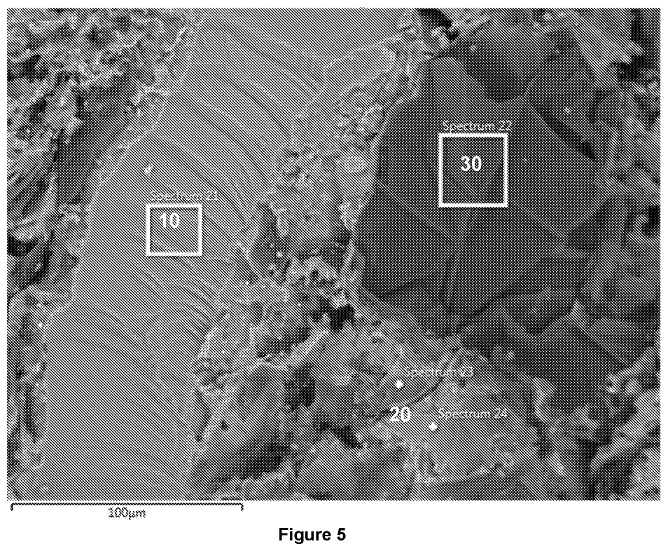

As illustrated in the SEM image of FIG. 5, the composite material composites a silicon carbide phase 10 and a graphite phase 30 which is bonded together with a glassy bonding phase 20. EDS spectra confirmed that silicon carbide phase 10 comprised silicon and carbon; the graphite phase 30 comprised essentially carbon and the glassy bonding phase 20 comprised calcium, aluminium, silicon, iron and oxygen. Wollastonite fibres detected by the XRD spectra (FIG. 2) would be expected to be embedded in the glassy bonding phase 20. The image confirms that the glassy bonding phase is securely bonding to the silicon carbide and graphite phase with no substantial presence of voids in the structure.

Hot Flexural Strength

C-2: standard clay bonded mix with 0% wollastonite.

C-3: standard clay bonded mix with 0% wollastonite with vacuum impregnation with a borax-boric acid solution and subsequently fired at 980° C.

E-4: standard clay bonded mix with 2.5 wt % wollastonite.

E-5 standard clay bonded mix with 2.5 wt % wollastonite with vacuum impregnation in accordance with C-3.

The results (Table 2) demonstrate that the addition of wollastonite decreases porosity by 19% prior to vacuum impregnation; and that hot flexural strength (or Hot Modulus of Rupture (HMOR)) substantially increases at 800° C., the maximum operating temperature of the apparatus in contact with molten aluminium. The wollastonite examples have a decreased hot flexural strength at 1200° C. due to the softening of the glassy bonding phase at these elevated temperatures.

TABLE 2

| | C-2 | C-3 | E-4 | E-5 |
|---|---|---|---|---|
| Density, gm/cc | 2.19 ± 0 | 2.22 ± 0 | 2.19 ± 0 | 2.22 ± 0 |
| Porosity, % | 16 ± 0 | 14 ± 0 | 13 ± 1 | 13 ± 1 |
| TBS, MPa | 8 ± 1 | 9 ± 1 | 10 ± 1 | 11 ± 1 |
| @RT | | | | |
| HMOR, MPa | 3.68 ± 1 | 5.85 ± 0 | 5.24 ± 1 | 8.04 ± 1 |
| @800° C. | | | | |
| HMOR, MPa | 4.50 ± 2 | 4.44 ± 0 | 4.05 ± 1 | 2.57 ± 0 |
| @1200° C. | | | | |
| Thermal | NA | 35.6 | NA | 32 |
| conductivity, | | | | |
| W/mK at RT | | | | |
| % Weight loss | 5.3 ± 0.5 | 3.6 ± 0.2 | 4.9 ± 0.4 | 2.7 ± 0.1 |
| @ 750/1 Hr. | | | | |

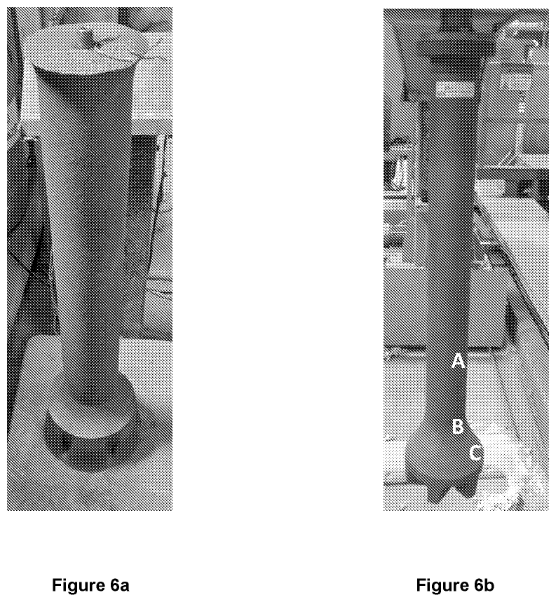

FIG. 6a is a photo of a one piece shaft/rotor apparatus for the use in molten aluminium refining. FIG. 6b is a photo of the same apparatus after machining has taken place, resulting in a graduated shaft diameter between line BC. The interface angle between the shaft and rotor (angle ABC) is approximately 150° resulting in a mechanically robust shaft/rotor free of any connection joint (i.e. integral). The intersection joint ABC is defined by a radius of 25 mm.

The material of construction is such that the usually high wear rotor component is sufficiently high wearing that a two piece design is not required to enable the rotor to be regularly replaced due to performance deterioration resulting from erosion of the rotor.

### Additional Examples

The following examples provide a variety of formulations used to produce composite materials comprising a glassy bonding phase derived from wollastonite. The relevant functionality of the derived composites extends beyond the reported TBS and oxidative resistance. Changes to the proportion of the components influence other functionality including thermal shock, hardness and HMOR.

Resin Bonded Formulations

TABLE 3

| | R 1 | R 2 | R 3 | R 4 | R 5 | R 6 | R 7 | R 8 | R9 |
|---|---|---|---|---|---|---|---|---|---|
| Wollastonite, wt % | 1.0 | 2.5 | 3.5 | 5.0 | 10 | 10 | 10 | 10 | 7.0 |
| SiC, wt % | 30 | 39 | 39 | 40 | 42 | 20 | 10 | 57 | 38 |
| Graphite, wt % | 40 | 35 | 30 | 25 | 20 | 39 | 43 | 5 | 40 |
| Si wt % | 9.5 | 10 | 10 | 6 | 11 | 11 | 11 | 2 | 0 |
| FeSi wt % | 3 | 3 | 3 | 2.5 | 2.5 | 2.5 | 2.5 | 2.5 | 0.5 |
| Borax wt % | 3.5 | 3.5 | 3.5 | 3.5 | 3.5 | 3.5 | 3.5 | 3.5 | 3.5 |
| Clay, wt % | 3 | 1 | 1 | 8 | 1 | 10 | 10 | 10 | 5 |
| Alumina, wt % | 10 | 6 | 10 | 10 | 10 | 4 | 10 | 10 | 6 |
| Binder Resin, wt % | 10 | 10 | 10 | 10 | 10 | 10 | 10 | 10 | 10 |
| Density, g/cc | 2.06 | 2.08 | 2.01 | 2.15 | 2.13 | 1.86 | 1.86 | 1.97 | 1.90 |
| Porosity, v/v % | 14 ± 0 | 15 ± 1 | 20 ± 1 | 16 ± 0 | 18 ± 1 | 23 ± 1 | 23 ± 1 | 32 ± 0 | 24 ± 1 |
| TBS, MPa | 12 ± 0 | 13 ± 1 | 12 ± 1 | 13 ± 1 | 18 ± 0 | 6 ± 2 | 4 ± 0 | 2 ± 1 | 6 ± 0 |
| Oxidation at | 8 ± 2 | 6 ± 0 | 7 ± 1 | 7 ± 1 | 5 ± 1 | 7 ± 2 | 9 ± 2 | 6 ± 0 | 14 ± 1 |
| 750° C. for 1 hr | | | | | | | | | |

With reference to Table 3, examples R1 to R5 cover a range of wollastonite contents, with oxidation resistance values being generally reflective of the graphite content in the formulation. The TBS value remained relatively stable except for Example R5, which exhibited the highest transverse bending strength due to the specific balance of components. SiC content was found to have a positive correlation to strength, however example R8 where SiC highest, strength is reduced, due to less bonding phase resulting high porosity. Likewise, insufficient SiC may also adversely affect the TBS value, as indicated in Examples R6 & R7.

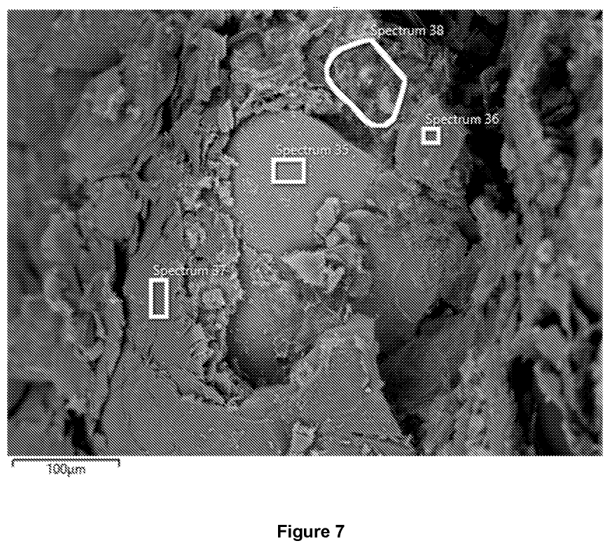

With Reference to FIG. 7 (Example R6), the resin bonded formulations when processed in accordance to the process as outline in FIG. 1b, results in a composite comprising silicon carbide particles (spectrum 35) embedded in graphite (spectrum 36 & 37) and the presence of a glassy bonding phase (spectrum 38). The glassy bonding phase contained the oxide forms of silicon, calcium and aluminium.

Examples R2 and R4 have the same strength, although the Si metal content in the formulation is lower in R4. This is attributed from higher wollastonite and clay content which forms an increased glassy bonding phase. The additional glassy bonding phase compensates for the reduced levels of beta SiC derivable from the lower silicon metal content in the starting formation. The reduced Si metal content in R4 has also resulted in a relatively higher oxidation rate taking into account the lower graphite level in Example R4.

Higher formation of glassy bonding phase and the presence of beta SiC (derived from Si metal and carbonised resin) in Example R7 results in improved oxidative resistance relative to the composite derived from the formulation in Example R9.

Clay Bonded Formulations

TABLE 4

| | C-A | C-B | C-C | C-D | C-E | C-F |
|---|---|---|---|---|---|---|
| Wollastonite, % | 0.5 | 10 | 1.0 | 10 | 1.0 | 10 |
| SiC, % | 15 | 15 | 25 | 25 | 50 | 40 |
| Graphite, % | 50 | 50 | 29 | 20 | 5 | 5 |
| Si Metal | 5 | 5 | 5 | 5 | 5 | 5 |
| FeSi % | 5 | 5 | 5 | 10 | 4 | 10 |
| Clay % | 24.5 | 15 | 35 | 30 | 35 | 30 |
| Density gm/cc | 2.07 | 2.05 | 2.20 | 2.16 | 2.35 | 2.19 |
| Porosity % | 15 ± 0 | 13 ± 1 | 13 ± 0 | 17 ± 2 | 16 ± 0 | 19 ± 1 |
| TBS, MPa | 15 ± 1 | 15 ± 1 | 17 ± 0 | 20 ± 1 | 24 ± 0 | 25 ± 4 |
| Oxidation at | 10 ± 2 | 9 ± 2 | 7 ± 1 | 5 ± 0 | 2 ± 1 | 2 ± 0 |
| 750° C. for 1 hr | | | | | | |

Table 4 illustrates a range of formulations and TBS and oxidative resistance of the derived composite materials formed in accordance to the process used for sample E-1. The wollastonite content of the formulations is at the boundaries of the preferred ranges, with the higher wollastonite content generally correlating to higher TBS values.

1. A molten metal processing apparatus comprising acomposite material comprising wollastonite fibres embedded within a ceramic matrix, wherein the wollastonite fibres are bonded to the ceramic matrix by a glassy bonding phase comprising a glass component comprising at least 80 wt % of oxides of calcium, silicon and aluminium.

2. The apparatus according to claim 1, wherein glassy bonding phase further comprises mullite.

3. The apparatus according to claim 1, wherein the mullite is in a form of crystallite particles embedded into the glass component.

4. The apparatus according to claim 1, wherein the wollastonite fibres are bondedly embedded into the glassy bonding phase.

5. The apparatus according to claim 1, wherein the comprises:
(a) 0.5 to 20 wt % wollastonite fibres;
(b) 0.5 to 40 wt % glassy bonding phase;
(c) 0 to 50 wt % ceramic matrix;
(d) 0 to 50 wt % carbon material; and
(e) 0 to 15 wt % other additives,
wherein a sum of components (a) to (e) is greater than 90 wt % of the composite material.

6. The apparatus of claim 5, wherein the carbon material comprises graphite and/or amorphous carbon.

7. The apparatus of claim 5, wherein the ceramic matrix comprises a beta silicon carbide and/or alpha silicon carbide.

8. The apparatus according to claim 1, wherein the glass component comprises greater than 90 wt % of oxides of calcium, aluminium and silicon.

9. The apparatus according to claim 1, wherein a content of oxides of aluminium and silica in the glass component is at least 60 wt %.

10. The apparatus according to claim 1, wherein there is a gradient of calcium concentration across the glass component of the glassy bonding phase.

11. The apparatus according to claim 1, wherein a concentration of calcium is higher in the glass component proximal to the wollastonite fibres relative to the glass component distal to the wollastonite fibres.

12. The apparatus according to claim 1, wherein the glassy bonding phase bonds the wollastonite fibre, ceramic matrix and/or graphite, if present, together.

13. The apparatus according to claim 1, wherein the ceramic matrix comprises one or more of silica; alumina; carbides of Si, Ti, W, Ta, Nb, Zr, Hf, V, Cr, Mo; silicon nitride; magnesia; zirconia; boron nitride; and aluminium nitride.

14. The apparatus according to claim 1, comprising:
(a) 0.5 to 10 wt % wollastonite fibres;
(b) 0.5 to 30 wt % glassy bonding phase;
(c) 20 to 50 wt % silicon carbide;
(d) 5.0 to 50 wt % graphite; and
(e) 1 to 15 wt % other additives,
wherein a sum of components (a) to (e) is greater than 90 wt % of the composite material.

15. (canceled)

16. The apparatus according to claim 15, wherein the apparatus is selected from the group consisting of a pump, a degasser, a flux injector and a scrap submergence device.

17. The apparatus according to claim 16, wherein the apparatus is a degasser and a shaft and/or a rotor of the degasser comprises the composite material.

18. The apparatus according to claim 17, wherein the apparatus comprises a shaft and a rotor, and wherein the shaft and the rotor comprise a one piece construction.

19. The apparatus according to claim 18, wherein the shaft comprises a diameter that gradually increases in size proximal to the rotor.

20. The apparatus according to claim 19, wherein an interface angle between the shaft and the rotor is at least 100°.

21. A process for producing the apparatus of claim 1 comprising:
(a) providing a precursor composite mixture comprising wollastonite fibres, a ceramic matrix and a glassy bonding phase or precursors thereof;
(b) depositing the mixture into a mould; and
(c) sintering the mixture at a temperature of at least 800° C. for sufficient time to partially transform the wollastonite fibres into the glassy bonding phase.

22-27. (canceled)
